(19) United States
(12) Patent Application Publication
(10) Pub. No.: US 2024/0428173 A1
(43) Pub. Date: Dec. 26, 2024

(54) Systems and Methods for Evaluating Models Using Candidate Job Analysis

(71) Applicant: RELATIVITY ODA LLC, Chicago, IL (US)

(72) Inventors: Aron Ahmadia, Arlington, VA (US); Michael Maletich, Chicago, IL (US); Greg Ott, Chicago, IL (US); Evan Curtin, Brooklyn, NY (US); Kenneth P. Dallmeyer, Inverness, IL (US)

(21) Appl. No.: 18/748,814

(22) Filed: Jun. 20, 2024

Related U.S. Application Data
(60) Provisional application No. 63/545,665, filed on Oct. 25, 2023.
(60) Provisional application No. 63/522,268, filed on Jun. 21, 2023.

(51) Int. Cl. G06Q 10/0639

(52) U.S. Cl. CPC G06Q 10/06398; G06Q 10/06393

(57) ABSTRACT

Systems and methods for evaluating performance of experimental code using a candidate jobs framework are provided. The techniques may include obtaining an indication of a module under evaluation; configuring a customer environment to provide an evaluation compute, separate from a customer compute executing customer-directed jobs, for executing the module under evaluation; deploying the module under evaluation in the customer environment, wherein deploying the module under evaluation causes the customer environment to execute the module under test using the evaluation compute; configuring the evaluation compute to operate under predetermined test conditions based on a script associated with the module under evaluation; and obtaining an evaluation metric from the customer environment, wherein the evaluation metric is representative of an execution of the module under evaluation based on the predetermined test conditions.

### CROSS-REFERENCE TO RELATED APPLICATIONS

This application claims priority to and the benefit of the filing date of provisional U.S. Patent Application No. 63/545,665 entitled “SYSTEMS AND METHODS FOR EVALUATING MODELS USING CANDIDATE JOB ANALYSIS,” filed on Oct. 25, 2023 and U.S. Patent Application No. 63/522,268 entitled “SYSTEMS AND METHODS FOR EVALUATING MODELS USING CANDIDATE JOB ANALYSIS,” filed on Jun. 21, 2023. The entire contents of the provisional applications are hereby expressly incorporated herein by reference.

### FIELD OF THE DISCLOSURE

The present disclosure relates generally to evaluate models, and more particularly to techniques that evaluate models based on anonymized and/or aggregated data.

### BACKGROUND

When performing analytics with a voluminous corpus of documents, models are often applied to analyze documents in depth, for example, to determine where and to what extent the documents are relevant. As such, improving and tailoring the models to perform the analytics may lead to large scale savings in efficiency, time, and resources.

However, attempts to improve the models often require a significant amount of training data to evaluate the models properly. For some tasks, such as searching patent documentation or discovery documents, relying upon historical data as training data may reveal personal and/or privileged details that cannot be exposed to third parties. Additionally, if the training data is overweighted with a particular dataset, bad actors may be able to reveal private and/or privileged information included in the training data.

For example, if a particular dataset is overrepresented or overweighted in training data or in data being analyzed to evaluate a model, a bad actor may reverse engineer output data to determine what data was input by a user. In some circumstances, such data may be private, such as search information that a user does not expect to be exposed to a third party. Alternatively, such data may be actively protected or may be associated with an expectation of privacy. For example, such data may be or include information regarding an invention that is subject to confidentiality requirements, information that may be protected as a trade secret, or information that is personally private or protected, such as medical information, financial information, etc. As such, protecting the privacy of user data may be an important concern when producing or improving models that act upon user data.

Conventionally, aggregation and anonymization techniques are applied to protect the privacy underlying training data. However, conventional techniques are often unable to truly anonymize the underlying data and/or fail to sufficiently aggregate the data. Further, the conventional aggregation and anonymization techniques may be unable to generate sufficiently comparable data to properly evaluate the performance of new models in development that may improve upon the models currently deployed in customer environments.

Moreover, testing new functionality for a customer environment and/or performing stress tests to test the performance of various functionalities and/or operations for a customer environment traditionally requires either direct access to the customer environment, leading to potential exposure of private data, or the use of simulations of the customer environment in a development environment, which may include inaccuracies and/or assumptions made that may cause problems in real deployment of the functionalities in question.

Accordingly, there is a need for systems and methods for evaluating modules, testing performance, and/or implementing new functionalities using the disclosed candidate job analyses.

### BRIEF SUMMARY

Techniques and systems for evaluating modules while maintaining and protecting data privacy are discussed in greater detail herein. In particular, the techniques and systems discussed herein allow for a user to evaluate a module while aggregating and/or anonymizing data in sufficient quantities so as to ensure anonymity of data from any individual user or environment. Depending on the implementation, the techniques and systems herein may determine that data is not sufficiently anonymized and/or may perform further anonymization on the module evaluation data to ensure that the data is sufficiently anonymized before permitting systems to interact with any output data or metrics. In further embodiments, the instant techniques and systems may further include configuring the environment to operate under predetermined test conditions (e.g., to perform a stress test and/or to test a new functionality without an available user interface).

In one embodiment, a method for evaluating models based on obtained data is provided. The method may include (1) obtaining, by one or more processors supporting a development environment, an indication of a module under evaluation, wherein the module under evaluation implements an AI model; (2) configuring, by the one or more processors, a plurality of customer environments to provide respective evaluation computes, separate from respective computes executing customer-directed jobs, for executing the module under evaluation; (3) deploying, by the one or more processors, the module under evaluation in the respective customer environments, wherein deploying the module under evaluation causes the respective customer environments to execute the module under test using the respective evaluation computes to generate one or more evaluation metrics regarding the module under evaluation; and (4) obtaining, by the one or more processors, anonymized evaluation metrics from the respective customer environments, wherein the anonymized evaluation metrics are representative of a performance of the model when executed at the plurality of customer environments.

In another embodiment, a method for evaluating module performance under various conditions based on obtained data is provided. The method may include (1) obtaining, by one or more processors supporting a development environment, an indication of a module under evaluation; (2) configuring, by the one or more processors, a customer environment to provide an evaluation compute, separate from a customer compute executing customer-directed jobs, for executing the module under evaluation; (3) deploying, by the one or more processors, the module under evaluation in the customer environment, wherein deploying the module under evaluation causes the customer environment to execute the module under test using the evaluation compute; (4) configuring, by the one or more processors, the evaluation compute to operate under predetermined test conditions based on a script associated with the module under evaluation; and (5) obtaining, by the one or more processors, an evaluation metric from the customer environment, wherein the evaluation metric is representative of an execution of the module under evaluation based on the predetermined test conditions.

### BRIEF DESCRIPTION OF THE DRAWINGS

FIG. 1 illustrates an example environment including a development environment and a customer environment at which the disclosed techniques may be implemented, according to an embodiment;

FIG. 2 illustrates an example signal diagram depicting messages communicated between various components of the development environment and a customer environment of FIG. 1, according to an embodiment;

FIG. 3 illustrates an exemplary computing system architecture for the development environment of FIG. 1, according to an embodiment;

FIG. 4 illustrates an example flow diagram of a method for evaluating modules based on obtained data, according to an embodiment; and

FIG. 5 illustrates an example flow diagram of a method for evaluating performance of modules under predetermined test conditions, according to an embodiment.

### DETAILED DESCRIPTION

The present techniques relate to the evaluation of modules by performing candidate jobs in a customer environment. In particular, a performance evaluation module of a development environment may deploy software modules under evaluation to a one or more customer environments and execute one or more candidate jobs to generate evaluation data, including evaluation metrics, for the module. The deployed modules may then report the evaluation data back to the development environment for analysis thereof. It should be appreciated that while aspects of the disclosure focus on the application of the candidate job framework to performance evaluation of modules, the candidate job architecture can be applied to conduct other types of experiments within customer environments.

In some embodiments, the system may ensure the anonymity of the evaluation data. For example, the development environment may prevent certain fields of data from being exported out of the customer environments. As another example, the system may include an anonymizer module that analyzes the evaluation data before providing the evaluation data to a performance evaluation module of the development environment. In this example, the anonymizer may ensure that the evaluation data is captured from a sufficient number of customer environments such that the aggregated evaluation data is not representative of any one customer environment beyond a threshold similarity. Additionally, the anonymizer may perform other analyses on the evaluation data to ensure that the data being received is not private customer data. For instance, the anonymizer may perform classification techniques to detect evaluation data that is similar to data fields that are prevented from export.

As such, privacy of the customer data in their customer environments is built into the performance evaluation process. Thus, developers may generate new models and evaluate their performance using real-world test data without breaching customer privacy requirements. Further, a device operating in a development environment may use the gathered and anonymized data to train various components and/or functionalities of the device, as described herein.

As it is generally used herein, the term “candidate job” refers to a job executed by a customer environment to implement a module under test developed at a development environment. As described in more detail further herein, the modules implemented by the customer environments may include models that relate to search, classification, sentiment analysis, and/or other types of machine learning models utilized to analyze the data sets maintained at the customer environments. Accordingly, the modules may generate one or more candidate jobs to experimentally test the corresponding models in the customer environment.

By utilizing the techniques and methods herein, a system as described provides an improvement over conventional systems at least by providing a framework for evaluating models in development with real-world data while still systematically maintaining the privacy of the data within the customer environments. Moreover, by routing the evaluation data to an anonymizer prior to providing the data to a performance evaluation module, the techniques described herein prevent malicious actors from maliciously deploying modules for the purpose of exposing information associated with the customer environment.

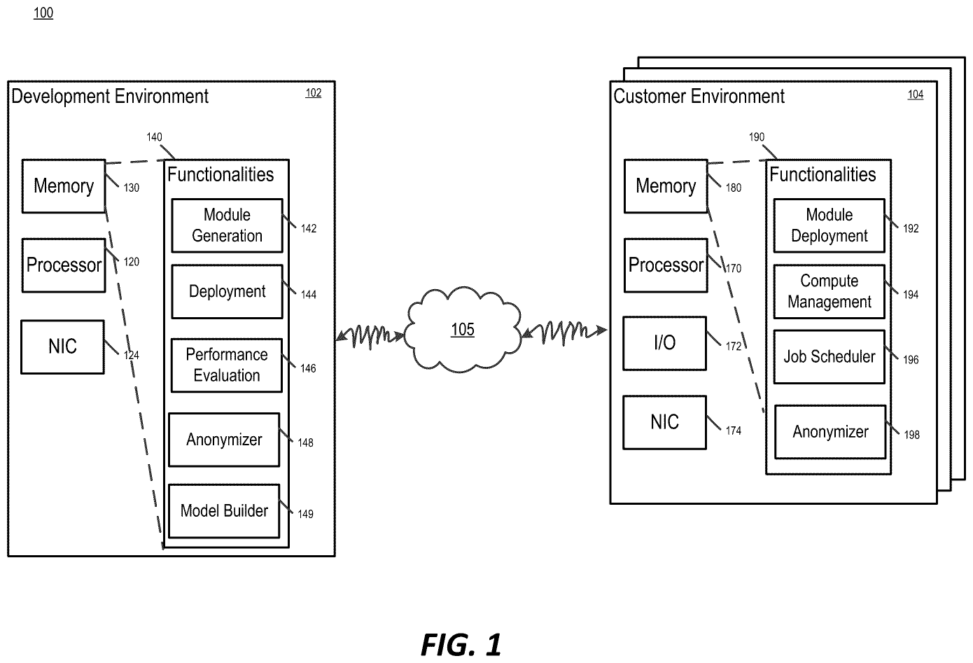

FIG. 1 depicts an example computing environment 100 that may be used to implement the disclosed performance evaluation techniques. As illustrated, the environment 100 includes a development environment 102 communicatively coupled to one or more customer environments 104 via network 105. The network 105 may be a single communication network or may include multiple communication networks of one or more types (e.g., one or more wired and/or wireless local area networks (LANs), and/or one or more wired and/or wireless wide area networks (WANs) such as the Internet). The development environment 102 and the customer environment 104 may be logical entities of a computing system supported by one or more terminals, web servers, back-end servers, or any combination thereof. The various environments 102, 104 described herein may be logically and/or physically separated such that data included in one environment is not readily accessible by the other environment(s) except via one or more pre-defined interfaces.

As illustrated, the development environment 102 also includes a network interface controller (NIC) 124. The NIC 124 may include any suitable network interface controller(s), such as wired/wireless controllers (e.g., Ethernet controllers), and may facilitate bidirectional/multiplexed networking over the network 105 between the development environment 102 and other components of the environment 100 (e.g., the customer environment 104, hardware units that support the development environment 102 in a distributed computing environment, etc.).

The development environment 102 includes a processor 120 that executes the various modules associated with the development environment 102. While referred to in the singular, the processor 120 may include any suitable number of processors of one or more types (e.g., one or more microprocessors, one or more CPUs, one or more GPUs, etc.). Generally, processor 120 is configured to execute software instructions stored in one or more memories 130 (e.g., stored in a persistent memory such as a hard drive or solid state memory) of the development environment 102. It should be appreciated that certain instructions may be more efficiently executed by different types of processors (e.g., generating a rendering of a content item may be more efficiently performed by a GPU, whereas as the establishment of a workspace may be more efficiently executed by a CPU). Accordingly, the development environment 102 may be configured to execute different instructions using the different processor types. Additionally, while FIG. 1 depicts a single processor 120 and a single memory 130, the processor 120 and the memory 130 may include any number of processors or memories, including processors and memories located in different physical units and/or connected via a distributed computing platform. It should be appreciated in the distributed computing embodiments, the physical processors and/or memories that support any given environment 102, 104 may only be utilized in that environment 102, 104.

Depending on the embodiment, the development environment 102 may be communicatively coupled to and/or include one or more databases (not shown) including, for example, patent publications, communication documents, research papers, workflow associated with one or more documents (e.g., a sequencing order associated with the one or more documents), metadata associated with one or more documents, etc. Such a database may be implemented using a relational database management system (RDBMS) such as MySQL, PostgreSQL, Oracle, etc. or a non-relational database structure, such as a NoSQL structure.

The development environment 102 may store and/or perform a number of functionalities 140 (e.g., via segmented units, via a cohesive whole, etc.) via software instructions in a memory 130 as described below. In particular, the software instructions stored in the memory 130, when executed by the processor 120, implement the functionalities 140. Depending on the embodiment, the functionalities 140 may include any or all of a module generation functionality 142, a deployment functionality 144, a performance evaluation functionality 146, an anonymization functionality 148, etc. It will be understood that the functionalities 140 are not limited to those discussed above, and that the development environment 102 may include additional, fewer, or alternative functionalities as discussed herein.

In some embodiments, the development environment 102 executes a module generation functionality 142 to generate a module for generating and/or executing one or more candidate jobs in the customer environments 104. For example, a module may include a model configured to perform a search (e.g., of one or more databases of content items), identify document sentiment (e.g., among one or more surveys, communication documents, etc.), label documents or phrases, and/or other analyses. In some such embodiments, the model may be or include a machine learning and/or artificial intelligence (AI) model and/or model with similar functionality (e.g., a large language model (LLM), a generative AI model, a neural network, etc.).

In further embodiments, the module generation functionality 142 may additionally generate and/or provide a workflow associated with one or more documents used as input to a model and/or associated with the model. For example, a workflow may include a sequencing order of one or more documents (e.g., patent documents, emails, etc.). The sequencing order may indicate an order in which the documents were received, should be read, should be prioritized, etc. Depending on the embodiment, the workflow may additionally include an indication of one or more potential workflows as well as instructions or another such indication of a parameter by which to compare the documents. For example, the module may include an LLM to analyze a plurality of documents, and the workflow may include an indication of multiple sequencing orders along with an indication to determine which workflow provides the most accurate determination, the fastest determination, the determination based off of fewest documents analyzed, etc.

In further implementations, the module generation functionality 142 may generate modules including instructions to perform additional jobs (e.g., the configure a compute to replicate circumstances such as resource strain) and/or to perform functionalities not currently available to customers via the modules currently deployed in the customer environment 104. To facilitate the generation of the module, the module generation functionality 142 may receive instructions, parameters, data, etc. from one or more users of the development environment 102 and/or devices communicatively coupled to the development environment 102. Depending on the embodiment, the received data may include metadata associated with one or more documents (e.g., professions associated with names in a document, relation between documents, workflow sequencing of documents, etc.). Similarly, the received data may include data generated by one or more models, including the models generated as part of the module (e.g., iterative analysis by the model).

According to certain aspects, the module generation functionality 142 may include one or more user interfaces that enable a user to design an experiment implemented by the module. For example, the user interfaces may enable the user to identify a model in a module to be evaluated within the customer environment. As another example, the user interfaces may enable the user to configure what data is input into the model and/or module. For example, the customer environments may maintain a script that specifies the operations performed within the customer environment (e.g., that a customer conducted a search for topic X and received search results A, B, C, or that a customer labeled document Y with label D, etc.). In some embodiments, the script may represent historical jobs performed by the customer environment 104 and/or the particular sets of data acted upon by the jobs. In some such embodiments, the historical data may include and/or be associated with an audit log indicating a sequence of customer interactions with the particular customer environment 104. Depending on the embodiment, the audit log may be or include information such as labeling decisions applied to a plurality of documents maintained at the customer environment. Accordingly, the user interface may enable the user to identify a script, historical data of a script, one or more audit logs of a script, etc. to utilize as the inputs to the model or module and/or any job type filters such that the module only recreates a specific type of job included in the script. In some embodiments, while the module generation functionality 142 may enable the user to select a particular audit log, to ensure customer data privacy, the module generation functionality 142 may prevent the user from viewing the content of the selected audit log.

As another example, the user interfaces may enable the user to configure what evaluation data and/or evaluation metrics for the module are able to be exported back to the development environment 102. For example, the types of evaluation data and/or evaluation metrics may be specifically restricted to specific fields that do not expose sensitive client data. For example, if the model is a classification model, the module generation functionality 142 may only permit the export of a limited set of characteristics associated with the model (e.g., a time until trained, a model stability metric, model precision, model recall, model elusion, and/or other classifier metrics). As another example, if the model is a search model, the module generation functionality 142 may only permit the export of, for example, a response time, an indexing time, and/or other metrics of model performance. By restricting the particular fields of evaluation data and/or evaluation metrics that can be exported, the module generation functionality 142 may prevent users from designing modules that are capable of generating evaluation metrics indicative of the specific type of data maintained in the customer environments 104.

After the user of the development environment 102 finishes designing the module, the module generation functionality 142 may convert the experiment information into experimental code for execution at the customer environments 104 and invoke a deployment functionality 144 to deploy a module that includes the experimental code. The deployment functionality 144 may be configured to present one or more user interfaces that enable a user to control how the designed module is deployed. For example, the deployment functionality 144 may enable the user to define one or more inclusion criteria (e.g., a size of document corpus, a technical field of the document corpus, an entity identifier, etc.) for which customer environments 104 the designed module is to be deployed.

In some embodiments, the user may design an A/B test to evaluate multiple models and/or multiple modules. Accordingly, the deployment functionality 144 may enable the user to select multiple modules designed via the module generation functionality 142 to deploy as part of a coordinated evaluation process. In this scenario, if the user indicates that multiple modules are to be evaluated against each other, the deployment functionality 144 may segment the customer environments 104 that satisfy the inclusion criteria into respective sets of customer environments 104 for each module. The deployment functionality 144 may ensure that there is sufficient similarity between the sets of customer environments 104 to ensure that the A/B test is fairly constructed.

The deployment functionality 144 may then deploy the designed module at the corresponding customer environments 104. Depending on the embodiment, deploying the designed module may include storing model data and the related code in a memory associated with the customer environments 104.

In some embodiments, the deployment functionality 144 generates one or more configuration messages associated with deploying the designed module (e.g., as one or more data packets, data capsules, and/or other similar data containers). For example, the deployment functionality 144 may cause the respective customer environments 104 to spin up additional compute resources dedicated to the execution of the candidate job generated by the designed module. In this example, because the candidate jobs are executed by dedicated compute resources, the execution of the candidate jobs may have minimal performance impact on the computes of the customer environment 104 executing the customer-directed jobs. Further, accounting data associated with the dedicated computes may include an indicator such that the costs are assigned to an operator of the development environment 102 as opposed to an operator of the customer environment 104.

The development environment 102 may additionally include one or more functionalities 140 associated with evaluating data received from the customer environment 104 using the generated model(s). For example, in some embodiments, the development environment 102 includes a performance evaluation functionality 146. Depending on the embodiment, the performance evaluation functionality 146 may analyze data including, in some implementations, evaluation metrics received from the customer environment 104. As some examples, the evaluation metric may be based on at least one of: (i) reliability, (ii) stability, (iii) training time, (iv) precision, (v) recall, (vi) area under a model curve, (vii) accuracy, (viii) adjusted mutual information, (ix) explained variance, (x) maximum error, (xi) mean absolute error, (xii) root mean squared error, (xiii) depth of recall, (xiv) throughput, (xv) latency, (xvi) resource usage, (xvii) memory, (xviii) CPU/CPU usage, (xix) network/network usage, (xx) IOPS/IOPS usage, (xxi) success/failure rates, and/or (xxii) any other such metric as relevant to one or more tasks being performed by the model/module or the general model/module performance.

In some embodiments, the performance evaluation functionality 146 receives aggregated and/or otherwise anonymized data from the customer environment 104 regarding module deployed by the deployment functionality 144. In further embodiments, the performance evaluation functionality 146 analyzes the received data to generate one or more evaluation metrics. In some such embodiments, the performance evaluation functionality 146 may compare the evaluation metrics to a baseline generated based on the modules currently implemented by the customer environments 104. In the case of an A/B test, the performance evaluation functionality 146 may also compare the two (or more) deployed models or modules against one another to determine which model or module performed better.

In some embodiments, the performance evaluation functionality 146 provides the determined difference(s) in evaluation metrics to another functionality 140 (e.g., the module builder functionality 149) to incorporate into a new module for deployment as part of an updated and/or official release. In further embodiments, the performance evaluation functionality 146 generates one or more user interfaces to enable a user to visually compare the performance of the deployed modules to one or more baselines. For example, the performance evaluation functionality 146 may provide one or more recommendations, suggestions, solutions, and/or other such indications of modifications, updates, etc. to the module under evaluation. The performance evaluation functionality 146 provides the one or more indications such that a user is able to determine one or more modifications to make to the module under evaluation without being exposed to confidential data. For example, the performance evaluation functionality 146 anonymizes the data before displaying the anonymized data (e.g., in conjunction with a recommendation) via a generated user interface by operating in conjunction with an anonymizer functionality 148 as described herein.

In some embodiments, the functionalities 140 of the development environment 102 include an anonymizer functionality 148. Depending on the embodiment, the anonymizer functionality 148 may be a part of the development environment 102 or a module of a separate component communicatively coupled to the development environment 102. In some such embodiments, the anonymizer functionality 148 receives evaluation data generated by the modules deployed to the customer environment 104 and only provides the data to another component of the development environment 102 (e.g., the performance evaluation functionality 146) after determining that data is sufficiently anonymized.

In some embodiments, the anonymizer functionality 148 determines that the data is sufficiently anonymized when the anonymizer functionality 148 detects that a similarity between evaluation data (or evaluation metrics derived from the evaluation data) received from any one customer environment 104 lacks sufficient similarity to aggregated evaluation data across all of the customer environments 104 at which the module was deployed. As another example, the anonymizer functionality 148 may ensure that evaluation data (or evaluation metrics of the evaluation data) from a threshold number of customer environments 104 (e.g., 10, 25, 50, and so on) are aggregated. In some embodiments, the anonymizer functionality 148 detects whether data is sufficiently anonymized by attempting to determine the origins of the data (e.g., according to B2C or other privacy standards).

In another aspect, the anonymizer functionality 148 may also perform semantic analyses of the underlying evaluation data to determine that no confidential customer data has been exposed. For example, the semantic analysis may detect names, topics, and/or other indicators of data that may be confidential. In some embodiments, the semantic analyses are performed by an artificial intelligence (AI) model. Alternatively, the anonymizer functionality 148 may perform a hashing operation on the confidential data to obfuscate the underlying data from the other functionality 140 of the development environment 102.

When the anonymizer functionality 148 determines that the aggregated evaluation data and/or evaluation metrics of the evaluation data are not sufficiently anonymized, anonymizer functionality 148 may transmit and/or otherwise cause the development environment 102 to display an error message to a user. In some such embodiments, the anonymizer functionality 148 discards the data and/or causes the development environment 102 to request further instructions from the user.

In some embodiments, the functionalities 140 of the development environment 102 include a model builder 149 configured to enable a user to generate a model for performing a particular analysis. For example, the models included in the modules generated by the module generation functionality 142 may be component models of a larger analytics model. As one example, the module under test may be or include an embedding model configured to convert an input document into an embedding vector thereof. As another example, the model may be a neural network architecture that acts upon vectors in the embedding space. Accordingly, if the performance evaluation functionality 146 determines that a model is an improvement upon a model included in a deployed module, the user may interface with the model builder functionality 149 to substitute the new model into the overall module.

Depending on the embodiment, the development environment 102 may perform each of the functionalities 140 autonomously. As such, the development environment 102 may deploy modules, evaluate modules, and/or anonymize data associated with module performance without user input, improving the privacy of the results and preventing users from viewing information kept separate at the customer environments 104.

The customer environment 104 may be configured to interface with the development environment via the network 105. For example, the customer environment 104 may detect configuration instructions and/or software modules for deployment from the deployment functionality 144 of the development environment. In the embodiment of FIG. 1, the customer environment 104 includes a processor 170. The processor 170 may include one or more microprocessors (e.g., one or more central processing units (CPUs) and/or one or more graphics processing units (GPUs)), for example. Additionally, the customer environment 104 includes a memory 180. The memory 180 may include a program memory that stores software instructions that form one or more functionalities 190 and a data memory configured to facilitate analytics applied to a corpus of documents (not depicted) maintained at the customer environment 104. Generally, the processor 170 is configured to execute software instructions stored in the program memory of the memory 180. The program storage may include one or more persistent memories (e.g., a hard drive and/or solid state memory) and a data memory, such as temporary memories, including buffers. In some embodiments, the data memory is a dedicated segment of a physical memory unit at the customer environment 104. Additionally or alternatively, the data memory may be a component of a graphics card or chipset included in the customer environment 104.

As illustrated, the customer environment 104 also includes a network interface controller (NIC) 174. The NIC 174 may include any suitable network interface controller(s), such as wired/wireless controllers (e.g., Ethernet controllers), and may facilitate bidirectional/multiplexed networking over the network 105 between the customer environment 104 and other components of the environment 100 (e.g., another customer environment 104, the development environment 102, etc.).

The customer environment 104 may store and/or perform a number of functionalities 190 (e.g., via segmented units, via a cohesive whole, etc.) via software instructions in a memory 180 as described below, similar to the development environment 102. In particular, the software instructions stored in the memory 180, when executed by the processor 170, implement the functionalities 190. Depending on the embodiment, the functionalities 190 may include a module deployment functionality 192, a compute management functionality 194, a job scheduler functionality 196, an anonymizer functionality 198, and/or other modules. It will be understood that the functionalities 190 are not limited to those discussed above, and that the customer environment 104 may include additional, fewer, or alternative functionalities as discussed herein.

In some embodiments, the compute management functionality 194 detects a request from the deployment functionality 144 to deploy a module in the customer environment 104. In response, the compute management functionality 194 may spin-up an additional compute dedicated to executing a module under evaluation. In this way, jobs generated by the module under evaluation may not collide with the jobs otherwise being executed in the customer environment 104 at the direction of the customer.

The module deployment functionality 192 may then receive one or more modules from the development environment 102 (e.g., via a corresponding deployment functionality 144) for deployment on the additional compute. For example, the module deployment functionality 192 may assign the module one or more workers configured to generate jobs in accordance with the code included in the received module. To this end, the module may generate jobs to load a model included in the module into the memory 180, to input data into the model, and/or produce evaluation data based on the model acting upon the input data.

In further embodiments, the module deployment functionality 192 may receive instructions from the development environment 102 that configure one or more operational parameters of the customer environment 104 and/or create jobs designed to stress test one or more resources of the customer environment 104 according to one or more predetermined test conditions. In some embodiments, the predetermined test conditions are designed by the development environment 102 to introduce stress into the system. For example, the predetermined test conditions may be representative of one or more additional users sharing physical resources with the evaluation compute. Accordingly, the candidate jobs that generate the predetermined test conditions may cause the evaluation compute to reflect the predetermined test conditions.

In one example, the module generated by the module deployment functionality 192 may be configured to generate candidate jobs that use a predetermined amount of available computing and/or memory resources of the evaluation compute (e.g., 10%, 25%, 50%, 70%, 80%, 90%, etc. of the available processing and/or memory resources). After generating the candidate jobs that create the stress condition of the evaluation compute, the module may then execute a functionality (e.g., a functionality currently deployed to the customer environment or a newly developed functionality) to determine whether the functionality executes as expected in the stressed condition. Depending on the embodiment, the predetermined test conditions may additionally or alternatively stress the evaluation compute by: (i) utilizing available computing and/or memory resources representative of a single user performing one or more additional large jobs (e.g., jobs that require 10%, 25%, 50%, 70%, 80%, 90%, etc. of resources for performing customer-directed jobs available for the evaluation compute), (ii) reducing bandwidth and/or otherwise introducing simultaneous communications to introduce network latency in the messaging flow of the evaluation compute, (iii) generating jobs to utilize memory so as to represent the effects of a memory leak in the evaluation compute, (iv) introducing packet loss in communications to and from the customer environment and/or evaluation compute and/or (v) any other such introduction of stress into the customer environment and/or evaluation compute.

For example, in some such embodiments, the module deployment functionality 192 receives an indication from the module generation functionality 142 to perform a functionality under test conditions of utilizing 70% of the available processing and/or memory resources. The module deployment functionality 192 may then generate and/or cause the job scheduling functionality 196 to schedule jobs until approximately 70% of the available processing and/or memory resources are used (e.g., by using an autoscaler or other automatic job creation and/or monitoring functionality). The module deployment functionality 192 and/or the compute management functionality 194 may then use historical records for the user (e.g., a script and/or audit log detailing operations performed by the user) to perform a previous job under the test conditions. The compute management functionality 194 may then record the results and/or statistics of the operation as described herein before anonymizing and/or exporting the results to the deployment environment 102.

In further embodiments, the evaluation compute spun up by the customer environment 104 to execute a module generated via the module generation functionality 142 runs separately and using separate resources from a customer compute (e.g., a compute used by a customer to perform jobs in the customer environment 104). Depending on the embodiment, the evaluation compute may mirror a customer compute (e.g., having similar or the same hardware, quantity of resources, available operations, configuration settings, etc.). In some such embodiments, the evaluation compute operates contemporaneously with the customer compute and mirrors operations as performed. In other such embodiments, the evaluation compute uses historical records of the customer compute (e.g., a script and/or audit log) to perform operations using a new module and/or test parameters after the customer finishes performing customer jobs.

In some embodiments, the customer environment 104 may receive a module and/or instructions to generate a module to perform a functionality not normally available in the customer environment 104 (e.g., prior to developing a user interface (UI) and/or UI elements that enable the user to perform the functionality). In some such embodiments, the module deployment functionality 192 and/or compute management functionality 194 may, for example, generate jobs in accordance with the module such that the jobs retrieve and/or input documents into the module and generate a classification score for each document. The module deployment functionality 192 and/or compute management functionality then associate, generate, and/or otherwise add the classification score for each document to an output and transmits the output to the development environment 102 and/or another computing device (e.g., via email, via a push notification, via an application receiving messages from the customer environment 104, etc.).

As one example, the module may be or include a large language model (LLM) (e.g., performing a generative AI and/or machine learning functionality). The LLM may retrieve and analyze documents to classify the documents, for example, by type (e.g., privileged vs. non-privileged), subject matter (e.g., responsive vs. non-responsive), keyword inclusion, entity association, and/or as otherwise discussed herein. The LLM may then append the classification scores to the documents and/or to a collection of information regarding the documents (e.g., a table of data regarding the documents) before transmitting the classification documents and/or the collection of information to the development environment 102.

As another example, a module configured to generate a graphical representation of various documents and relation to a central node (e.g., a keyword, a document, a subject, etc.) may receive documents associated with a job depicting a search performed by a user. The module may then generate the graphical representation and transmit the graphical representation to the development environment 102 and/or to another user.

In some embodiments, the module with additional functionality assists in determining and/or determines what coding decisions improved the performance by one or more metrics and may generate an output indicating what decisions to use, keep, or otherwise suggest to the development environment 102. The additional functionality module may then display, transmit, or otherwise provide access to the determinations for the development environment 102 (e.g., by displaying on a screen, by transmitting to the development environment 102, by emailing a user account associated with the development environment 102, etc.). As such, a user is able to quickly test and analyze a feature before developing, generating, or otherwise modifying a user interface (UI) to allow a customer to implement the feature.

In further embodiments, the functionalities 190 may provide one or more recommendations, suggestions, solutions, and/or other such indications of modifications, updates, etc. to the module under evaluation. The functionalities 190 may provide the one or more indications such that a user is able to determine one or more modifications to make to the data being analyzed by the module under evaluation without being exposed to confidential data (e.g., via the UI in conjunction with the anonymizer functionality 198).

In some such embodiments, the module performing additional functionality replaces and/or supplements the anonymizer functionalities 148/198. For example, in some embodiments in which the additional functionality module provides outputs to the development environment 102, a user associated with the development environment 102 only sees the determination with regard to classification scores, obviating a risk of confidential data being disclosed to the user.

The jobs generated by the module worker may be scheduled by a job scheduler functionality 196 of the customer environment 104. Generally, by spinning up the additional compute, the customer environment should have sufficient compute resources to execute the jobs generated by the module worker without colliding with the normal job flow of the customer environment 104. That said, there may occasionally be constraints on the overall amount of resources available to the customer environment, for example, when the customer environment is executing a compute-intensive training algorithm. In these situations, the job scheduler 196 may deprioritize the jobs generated by the deployed module to make the new compute resources available for use when executing the job flow associated with customer-directed operations.

As described above, the deployed module may implement a module to be evaluated within the customer environment 104, which includes code for routing input data to the module and for evaluating the module performance. Accordingly, the experimental code to evaluate the module included in the deployed module may generate jobs for execution at customer environment 104. For example, the experimental code includes an indication to recreate jobs included in a script and/or an audit log within the customer environment, but using the module under evaluation rather than the module currently-available to the customer. The job schedule 196 may ensure that the experimental code for testing the module is executed in a manner that minimizes the impact on the performance of the customer environment at performing customer-directed operations.

In some embodiments, the experimental code is designed to evaluate performance of an alternative embedding model for embedding documents when training a classifier. Accordingly, in these embodiments, the experimental code may utilize labeling decisions included in the scripts and/or audit logs as the training data for training a new classifier. In this example, the job scheduler 196 may schedule the jobs for embedding the documents using the model under test and/or for retraining the classifier when the performance of the customer environment 104 satisfies a performance metric (e.g., a size of a job queue, a data throughput, a processing rate, expected workload, etc.) before execution. As another example, the experimental code may be or include a different model for storing the documents in the corpus of documents. In this example, the job scheduler 196 may be able to schedule the jobs for building a search index of the data storage system when the performance of the customer environment 104 satisfies a performance metric (e.g., a size of a transaction queue with a storage system, a transaction processing time, etc.) before execution. In some such embodiments, the performance evaluation functionality 146 of the development environment 102 may configure the customer environment 104 to measure metrics such as time to response, depth of response, precision, recall, and/or any other metric described herein. Because the jobs generated by the experimental code are lower priority to the jobs generated at the client-direction and can be executed in a delayed manner, the jobs are referred to herein as “candidate jobs.”

In some embodiments, the experimental code includes code for generating evaluation data on the performance of the module. As one example, the experimental code may include code for generating precision and/or recall data on a model included in the module and the model deployed to the customer environment 104. In other embodiments, the experimental code includes indications of existing process metrics to utilize as evaluation data. As one example, an audit log may include indications of job execution time and/or metrics.

In some embodiments, the customer environment 104 includes an anonymizer functionality 198. Depending on the embodiment, the anonymizer functionality 198 may operate similarly to the anonymizer functionality 148 for the development environment 102. In some embodiments, both the anonymizer functionality 148 and the anonymizer functionality 198 may be included in the environment 100. In further embodiments, the anonymizer functionality 198 may be included while the anonymizer functionality 148 is not, and vice versa.

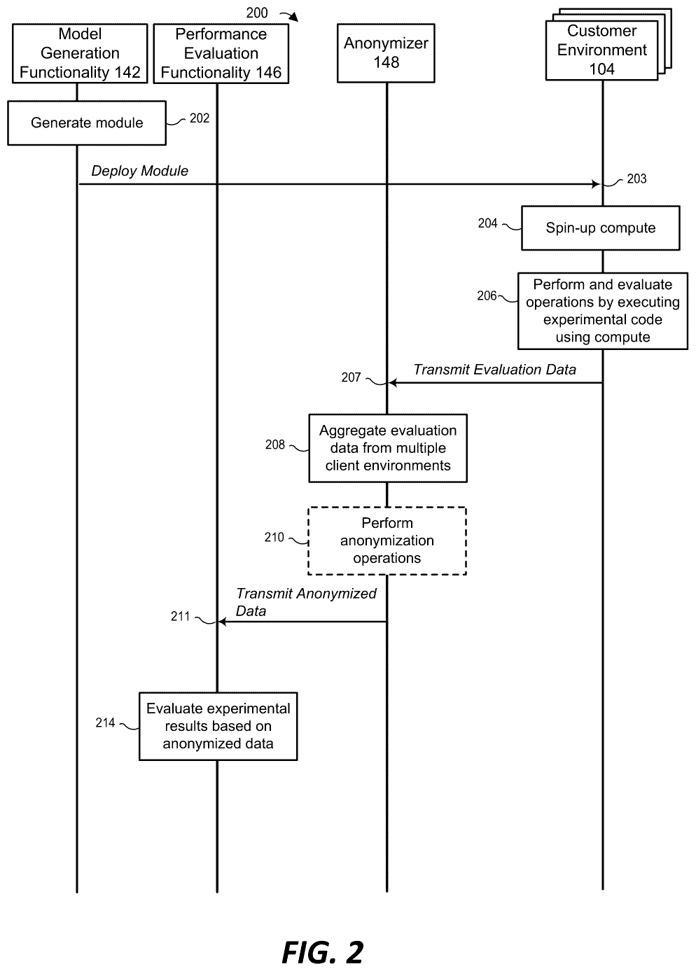

FIG. 2 depicts an example signal diagram 200 for evaluating a module across multiple customer environment based on anonymized evaluation data. In particular, a development environment (e.g., development environment 102 as described above with regard to FIG. 1) communicatively coupled to a customer environment (e.g., customer environment 104 as described above with regard to FIG. 1) may perform the operations described with respect to the signal diagram 200.

In the exemplary scenario 200, a module generation functionality 142 generates 202 a module to deploy in the customer environment 104. For example, the module may include experimental code designed to evaluate a model or other type of software module. In some embodiments, the module is an alternative version of a model currently deployed at the development environment 102. For example, a user may want to evaluate a different embedding model, a different search model, a different storage model, etc. The module generation functionality 142 may then generate a module including experimental code associated with the evaluation of the module. In still other embodiments, the module includes functionality that is not otherwise present in the customer environment 104 (e.g., use of an LLM to analyze documents, use of a generative artificial intelligence to review coding decisions, use of a graphical generation module, etc.). In further embodiments, the module includes instructions regarding test conditions under which a compute is to operate.

The development environment then invokes a deployment functionality, such as the deployment functionality 144 of FIG. 1, to deploy 203 the module to the customer environments 104. Depending on the embodiment, the deployment functionality may deploy 203 the module using a network (e.g., network 105 as described with regard to FIG. 1) via wireless means, a wired connection, etc.

As part of deploying the module, the customer environment 104 spins-up 204 a compute (e.g., via the compute management functionality 194 of FIG. 1). In some embodiments, the compute is dedicated to executing jobs generate by the module designed via development environment.

After spinning-up 204 the compute, the customer environment 104 then performs and evaluates 206 operations for the module using the spun-up compute. For example, the module may be assigned a worker that generates one or more candidate jobs for execution at the customer environment. A scheduler of the customer environment (such as the job scheduler 196 of FIG. 1) may then schedule the execution of the candidate jobs. In some embodiments, the job scheduler deprioritizes the execution of the candidate jobs such that the execution thereof has minimal impact on the execution of jobs generated at the customer direction. In some embodiments, the customer environment 104 receives an indication of particular test conditions via the module and generates candidate jobs to reflect the test conditions in the customer environment 104. For example, the module may indicate that a test is to be carried out at 70% resource usage and the customer environment 104 may generate jobs to use 70% of the available resources before performing and/or evaluating the operations.

After performing and evaluating 206 the operations, the customer environment 104 transmits 207 the evaluation data to an anonymizer. Depending on the embodiment, the anonymizer may be a component of the development environment 102 (e.g., anonymizer 148), or a separate component of a separate environment (not shown) communicatively coupled with the development environment 102 and the customer environment 104.

In some embodiments, the customer environment 104 transmits the evaluation data directly to a development environment 102 (e.g., the performance evaluation functionality 146). For example, in an implementation in which a new functionality is carried out at the customer environment responsive to receiving a module including the new functionality and/or in an implementation in which module operated under predetermined test conditions, the customer environment 104 may not be transmitting sensitive data, and the anonymizer 148 may be bypassed.

In embodiments in which the anonymizer 148 is part of the development environment 102, the anonymizer 148 may be at least partially isolated from other components of the development environment 102. For example, to ensure that the anonymizer 148 sufficiently anonymizes data, the anonymizer 148 may be configured to only transmit data to a particular component (e.g., the performance evaluation functionality 146) upon determining that received data is sufficiently aggregated and/or anonymized so as to avoid exposing information associated with the customer environment 104. Depending on the embodiment, the anonymizer 148 may include a semantic analysis tool configured to detect data streams typically associated with confidential information.

The anonymizer 148 receives the evaluation data, including one or more evaluation metrics, from the customer environments 104 and aggregates 208 evaluation data. In some embodiments, the anonymizer 148 determines whether evaluation data is sufficiently anonymized. For example, the semantic analysis tool of the anonymizer 148 may determine that at least one characteristic recognizable of a customer environment is recognizable. As another example, the anonymizer 148 may ensure that the evaluation data from each individual customer environment 104 lacks a threshold similarity to the aggregated evaluation data.

Depending on the embodiment, the anonymizer 148 performs 210 additional operations to further anonymize data upon determining that data is not sufficiently anonymized. For example, the anonymizer 148 may determine that the aggregated data stream is too similar to the evaluation data (or evaluation metrics of the evaluation data) from an individual customer environment. As another example, the anonymizer 148 may detects data that is indicative of user information and remove, hash, or otherwise scrub the data before any further transmission is performed.

After determining that the data is sufficiently anonymized, the anonymizer 148 transmits the anonymized data. More particularly, the anonymizer 148 may transmit 211 the anonymized evaluation data to the performance evaluation functionality 146 to evaluate 214 results of the experimental code included in the deployed module. For example, the performance evaluation functionality 146 may determine, based on the received anonymized data, whether the deployed model and/or module performed operations within a predetermined time period, whether the deployed model and/or module used more or fewer resources than another model and/or module, whether one or more predetermined metrics increased, decreased, or remained constant, etc.

In some embodiments, if the performance evaluation functionality 146 determines the evaluation data for the deployed module is an improvement upon, for example, existing models and/or modules included in the customer environments 104, the user may be provided an interface to integrate the deployed module into the customer-facing modules. As another example, the evaluation data or evaluation metrics of the evaluation data may be interpreted to identify other configuration updates that could improve the performance of the various modules executing in the customer environments 104.

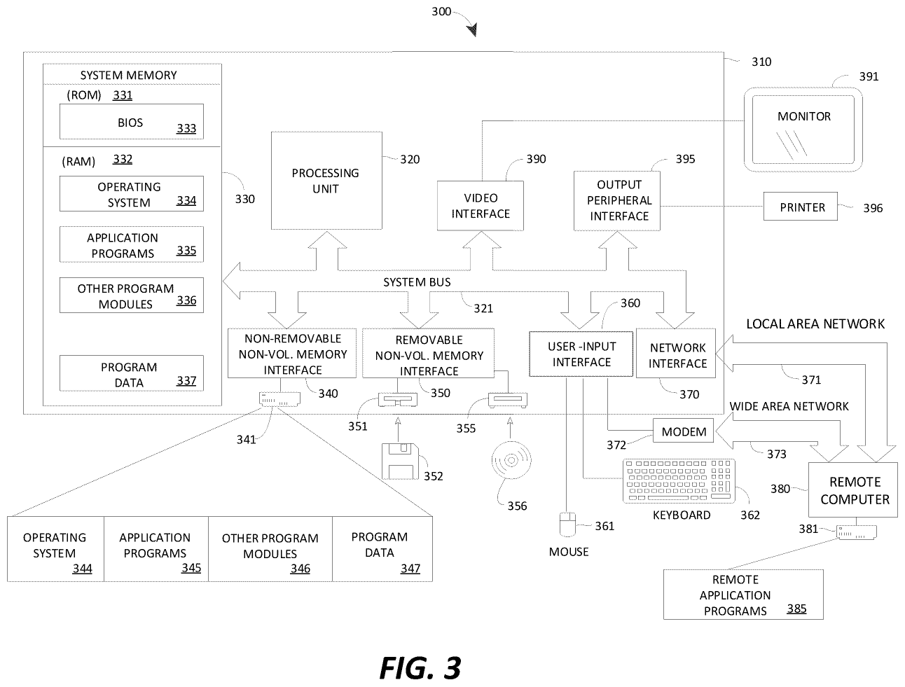

Turning now to FIG. 3, FIG. 3 depicts an example computing system 300 in which the techniques described herein may be implemented, according to an embodiment. For example, the computing system 300 of FIG. 3 may be a computing system with architecture configured to implement the development environment 102. While FIG. 3 depicts a computing system that implements a development environment, similar techniques may be implemented to implement a customer environment 104.

The computing system 300 may include a computer 310. Components of the computer 310 may include, but are not limited to, a processing unit 320, a system memory 330, and a system bus 321 that couples various system components including the system memory 330 to the processing unit 320. In some embodiments, the processing unit 320 may include one or more parallel processing units capable of processing data in parallel with one another. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 3 provide storage of computer-readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and may include many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 3 illustrates remote application programs 385 as residing on memory device 381.

In some embodiments, the computing system 300 is a server computing system communicatively coupled to a local workstation (e.g., a remote computer 380) via which a user interfaces with the computing the computing system 300. In further embodiments, the computing system 300 may include any number of computers 310 configured in a cloud or distributed computing arrangement. Accordingly, the computing system 300 may include a cloud computing manager system (not depicted) that efficiently distributes the performance of the functions described herein between the computers 310 based on, for example, a resource availability of the respective processing units 320 or system memories 330 of the computers 310.

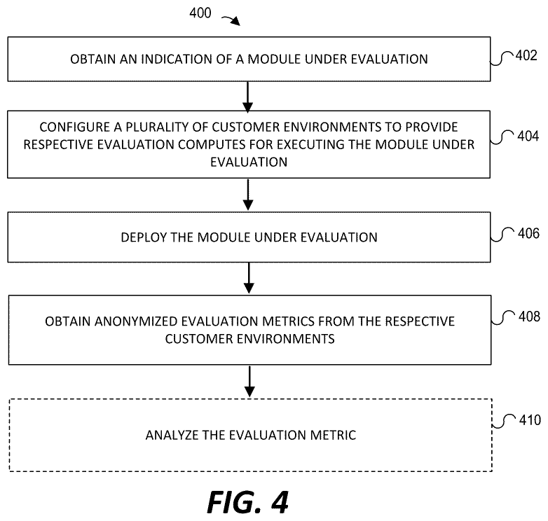

FIG. 4 depicts an example flow diagram 400 of a method for evaluating modules based on obtained data. More particularly, one or more processors supporting a development environment (e.g., development environment 102, 300) may execute one or more modules in conjunction with a customer environment (e.g., customer environment 104) to perform the method of flow diagram 400. For clarity, the method of flow diagram 400 is discussed with specific reference to elements as described herein with regard to FIG. 1. However, it should be understood that, depending on the embodiment, the method of flow diagram 400 may be implemented by other computing systems.

At block 402, the development environment obtains an indication of a module under evaluation. In some embodiments, the module under evaluation implements an AI model. For example, the module under evaluation may implement an alternative version of an AI model deployed at the respective customer environments. Depending on the embodiment, the module under evaluation may include a machine learning and/or artificial intelligence model (e.g., an LLM, a generative AI model, a neural network, etc.), a workflow associated with module under evaluation, metadata associated a model and/or workflow, etc.

At block 404, the development environment configures a plurality of client environments to provide respective evaluation computes, separate from respective computes executing client-directed jobs, for executing the module under evaluation.

At block 406, the development environment deploys the module under evaluation in the respective client environments to cause the respective client environments to execute the module under evaluation using the respective evaluation computes to generate evaluation data, including one or more evaluation metrics. For example, deploying the module under evaluation may cause the respective evaluation compute of the customer environments to execute the AI model using historical data maintained within the customer environment. In some embodiments, the historical data includes labeling decisions applied to a plurality of documents maintained at the particular customer environment.

Additionally or alternatively, the historical data may be associated with a script and/or an audit log indicating a sequence of customer interactions with the particular customer environment. In these embodiments, deploying the module under evaluation may cause the customer environment to perform the sequence of customer interactions to generate the evaluation data, including one or more evaluation metrics. In some embodiments, to generate the evaluation data, the customer environment determines a performance metric executes jobs generated by the module under evaluation responsive to the customer environment satisfying the performance metric.

At block 408, the development environment obtains anonymized evaluation data from the respective client environments. For example, the development environment may obtain an output of a data anonymizer configured to (1) analyze the evaluation data to classify data fields included in the evaluation data as being permissible or private; and (2) output the permissible data fields. Further, the evaluation data may include evaluation metrics indicating a performance of the AI model when executed at the plurality of customer environments. For example, the evaluation metrics may be include and/or be based upon at least one of: (i) reliability, (ii) stability, (iii) training time, (iv) precision, (v) recall, (vi) area under a model curve, (vii) accuracy, (viii) adjusted mutual information, (ix) explained variance, (x) maximum error, (xi) mean absolute error, (xii) root mean squared error, (xiii) depth of recall, (xiv) throughput, (xv) latency, (xvi) resource usage, (xvii) memory, (xviii) CPU/CPU usage, (xix) network/network usage, (xx) IOPS/IOPS usage, or (xxi) success/failure rates and/or compare performance of the AI model to the respective alternate versions of the AI model deployed at the respective customer environments.

At block 410, the development environment and/or one or more users utilizing the development environment may analyze the evaluation metrics. In some embodiments, the development environment may analyze the evaluation metrics to determine one or more modifications for the module (e.g., to an AI model of the module). In further such embodiments, the development environment the updates an AI model utilized in a customer environment based upon the analysis of the evaluation metrics and/or the determined modifications.

It should be appreciated that other embodiments may include additional, fewer, or alternative functions to those described with respect to FIG. 4. For example, functions described with respect to any of FIGS. 1-3 described herein may be combined with the functions described with respect to the flow diagram 400.

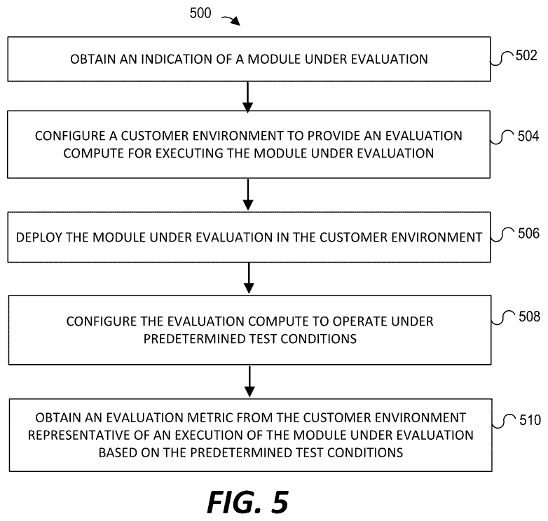

FIG. 5 depicts an example flow diagram 500 of a method for evaluating module performance under various test conditions based on obtained data. More particularly, one or more processors supporting a development environment (e.g., development environment 102, 300) may execute one or more modules in conjunction with a customer environment (e.g., customer environment 104) to perform the method of flow diagram 500. For clarity, the method of flow diagram 500 is discussed with specific reference to elements as described herein with regard to FIG. 1. However, it should be understood that, depending on the embodiment, the method of flow diagram 500 may be implemented by other computing systems.

At block 502, the development environment obtains an indication of a module under evaluation. For example, the module under evaluation may include and/or implement an alternative version of a module deployed at the respective customer environments. In further embodiments, the development environment receives an indication of a module under evaluation that introduces additional functionality, is to be evaluated under predetermined test conditions, etc. Depending on the embodiment, the module under evaluation may include a machine learning and/or artificial intelligence model (e.g., an LLM, a generative AI model, a neural network, etc.), a workflow associated with module under evaluation, metadata associated a model and/or workflow, etc.

At block 504, the development environment configures a customer environment to provide an evaluation compute, separate from respective computes executing customer-directed jobs, for executing the module under evaluation, similar to block 404 above. In some embodiments, the evaluation compute is configured to generate candidate jobs to satisfy one or more operation parameters (e.g., test conditions), as described below with regard to block 508. In further embodiments, the evaluation compute is configured to provide additional functionality (e.g., an LLM, a graphical representation generation model, etc.), as described herein.

At block 506, the development environment deploys the module under evaluation in the respective client environments to cause the customer environment to execute the module under evaluation using the evaluation compute under test using the evaluation compute. For example, deploying the module under evaluation may cause the respective evaluation compute of the customer environments to execute an AI model using historical data maintained within the customer environment.

At block 508, the development environment configures the evaluation compute to operate under predetermined test conditions. In some embodiments, the predetermined test conditions are representative of one or more additional users sharing physical resources with the evaluation compute. As such, the module may generate candidate jobs that use a predetermined amount of available computing and/or memory resources of the evaluation compute (e.g., 10%, 25%, 50%, 70%, 80%, 90%, etc. of the available processing and/or memory resources). After generating the candidate jobs that create the test conditions of the evaluation compute, the module may then execute a functionality (e.g., a functionality currently deployed to the customer environment or a newly developed functionality) to evaluate the functionality when executed under the test conditions. Depending on the embodiment, the predetermined test conditions may additionally or alternatively stress the evaluation compute by: (i) utilizing available computing and/or memory resources (e.g., 10%, 25%, 50%, 70%, 80%, 90%, etc. of processing and/or memory resources of the evaluation compute), (ii) reducing bandwidth and/or otherwise introducing simultaneous communications to introduce network latency in the messaging flow of the evaluation compute, (iii) generating jobs to utilize memory so as to represent the effects of a memory leak in the evaluation compute, (iv) introducing packet loss in communications to and from the customer environment and/or evaluation compute and/or (v) any other such introduction of stress into the customer environment and/or evaluation compute.

In some embodiments, the development environment further configures the evaluation compute based on a script. In some embodiments, the script is associated with at least some of the customer-directed jobs that a customer compute in the customer environment performs. For example, the script may represent historical jobs performed by the customer environment and/or the particular sets of data acted upon by the jobs. For example, the historical data may include an and/or be associated with a script including an audit log indicating a sequence of customer interactions with the particular customer environment. Depending on the embodiment, the audit log may be or include information such as labeling decisions applied to a plurality of documents maintained at the customer environment. Additionally or alternatively, the audit log may indicate a particular sequence of customer interactions with the customer environment. Depending on the embodiment, the audit log may be a first audit log (e.g., an original and/or recorded audit log), and development environment may cause (e.g., via configuring the customer environment and/or the evaluation compute, by deploying the module under evaluation, etc.) the customer environment to generate a second audit log that is representative of on the module under test when operating under the predetermined test conditions (e.g., past actions of the first audit log under the predetermined test conditions). In some such embodiments, the evaluation metrics are based on one or more differences between the first audit log and the second audit log.

In some alternate embodiments, the module generation functionality of the development may provide the ability to generate scripts using a script editor and/or by obtaining scripts from a script database that maintains scripts that are configured to perform a pre-defined set of actions.

At block 510, the development environment obtains an evaluation metric from the customer environment representative of an execution of the module under evaluation and based on the predetermined test conditions. In some embodiments, the evaluation metric is an anonymized evaluation metric as described herein. For example, the customer environment may be a first customer environment of a plurality of customer environments, and the anonymized evaluation metric includes and/or is an aggregation of evaluation metrics from each of the plurality of customer environments. Depending on the embodiment, the evaluation metric may be or include at least one of (i) reliability, (ii) stability, (iii) training time, (iv) precision, (v) recall, (vi) area under a model curve, (vii) accuracy, (viii) adjusted mutual information, (ix) explained variance, (x) maximum error, (xi) mean absolute error, (xii) root mean squared error, (xiii) depth of recall, (xiv) throughput, (xv) latency, (xvi) resource usage, (xvii) memory, (xviii) CPU usage, (xix) network usage, (xx) IOPS usage, (xxi) success or failure rates, and/or (xxii) any other such metric as described herein.

In some embodiments, after obtaining the evaluation metric, the development environment updates a module (e.g., the module under evaluation, similar modules in other customer environments, a module to replace the module under test, etc.) based upon the evaluation metric and/or an analysis of the evaluation metric. In further embodiments, the development environment updates the module by deploying an updated module with updated code (e.g., to address issues, inefficiencies, etc. detected while testing the module) for the module under evaluation based on the evaluation metric and/or the analysis.

It should be appreciated that other embodiments may include additional, fewer, or alternative functions to those described with respect to FIG. 5. For example, functions described with respect to any of FIGS. 1-4 described herein may be combined with the functions described with respect to the flow diagram 500.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for practicing the techniques disclosed herein through the principles disclosed herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

Moreover, although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

What is claimed:

1. A computer implemented method for evaluating module performance under various conditions based on obtained data, the method comprising:
obtaining, by one or more processors supporting a development environment, an indication of a module under evaluation;
configuring, by the one or more processors, a customer environment to provide an evaluation compute, separate from a customer compute executing customer-directed jobs, for executing the module under evaluation;
deploying, by the one or more processors, the module under evaluation in the customer environment, wherein deploying the module under evaluation causes the customer environment to execute the module under test using the evaluation compute;
configuring, by the one or more processors, the evaluation compute to operate under predetermined test conditions based on a script associated with the module under evaluation; and
obtaining, by the one or more processors, an evaluation metric from the customer environment, wherein the evaluation metric is representative of an execution of the module under evaluation based on the predetermined test conditions.

2. The computer implemented method of claim 1, wherein the script includes historical data maintained within the customer environment.

3. The computer implemented method of claim 2, wherein the historical data is associated with an audit log indicating a sequence of customer interactions with the customer environment.

4. The computer implemented method of claim 3, wherein the audit log is an audit log for a first customer and the predetermined test condition is representative of one or more second customers sharing physical resources with the first customer while performing one or more large second customer-directed jobs.

5. The computer implemented method of claim 3, wherein the audit log is a first audit log, and the deploying further causes the customer environment to generate a second audit log representative of one or more modified past actions based on the predetermined test conditions.

6. The computer implemented method of claim 5, wherein the evaluation metric is based on one or more differences between the first audit log and the second audit log.

7. The computer implemented method of claim 1, wherein the obtaining the evaluation metric includes obtaining an anonymized evaluation metric.

8. The computer implemented method of claim 7, wherein the customer environment is a first customer environment of a plurality of customer environments and the anonymized evaluation metric includes an aggregation of evaluation metrics from each of the plurality of customer environments.

9. The computer implemented method of claim 1, wherein the evaluation metric includes at least one of: (i) reliability, (ii) stability, (iii) training time, (iv) precision, (v) recall, (vi) area under a model curve, (vii) accuracy, (viii) adjusted mutual information, (ix) explained variance, (x) maximum error, (xi) mean absolute error, (xii) root mean squared error, (xiii) depth of recall, (xiv) throughput, (xv) latency, (xvi) resource usage, (xvii) memory, (xviii) CPU usage, (xix) network usage, (xx) IOPS usage, or (xxi) success or failure rates.

10. The computer implemented method of claim 1, further comprising:
updating, by the one or more processors, a module utilized in a customer environment based upon an analysis of the evaluation metric, wherein the updating includes deploying an updated module that modifies one or more parameters of the module based on the analysis.

11. The computer implemented method of claim 1, wherein the predetermined test conditions are representative of at least one of: (i) one or more additional large jobs by the customer environment, (ii) network latency in communications to and from the customer environment, (iii) memory leak in the customer environment, or (iv) packet loss in communications to and from the customer environment.

12. A system configured for evaluating module performance under various conditions based on obtained data, the system comprising:
one or more processors supporting a development environment; and
a memory storing machine-readable instructions that, when executed, cause the one or more processors to:
obtain an indication of a module under evaluation;
configure a customer environment to provide an evaluation compute, separate from a customer compute executing customer-directed jobs, for executing the module under evaluation;
deploy the module under evaluation in the customer environment, wherein deploying the module under evaluation causes the customer environment to execute the module under test using the evaluation compute;
configure the evaluation compute to operate under predetermined test conditions based on a script associated with the module under evaluation; and
obtain an evaluation metric from the customer environment, wherein the evaluation metric is representative of an execution of the module under evaluation based on the predetermined test conditions.

13. The system of claim 12, wherein the script includes historical data maintained within the customer environment.

14. The system of claim 13, wherein the historical data is associated with an audit log indicating a sequence of customer interactions with the customer environment.

15. The system of claim 14, wherein the audit log is an audit log for a first customer and the predetermined test condition is representative of one or more second customers sharing physical resources with the first customer while performing one or more large second customer-directed jobs.

16. The system of claim 14, wherein the audit log is a first audit log, and the deploying further causes the customer environment to generate a second audit log representative of one or more modified past actions based on the predetermined test conditions.

17. The system of claim 12, wherein obtaining the evaluation metric includes obtaining an anonymized evaluation metric.

18. The system of claim 17, wherein the customer environment is a first customer environment of a plurality of customer environments and the anonymized evaluation metric includes an aggregation of evaluation metrics from each of the plurality of customer environments.

19. The system of claim 12, wherein the evaluation metric includes at least one of: (i) reliability, (ii) stability, (iii) training time, (iv) precision, (v) recall, (vi) area under a model curve, (vii) accuracy, (viii) adjusted mutual information, (ix) explained variance, (x) maximum error, (xi) mean absolute error, (xii) root mean squared error, (xiii) depth of recall, (xiv) throughput, (xv) latency, (xvi) resource usage, (xvii) memory, (xviii) CPU usage, (xix) network usage, (xx) IOPS usage, or (xxi) success or failure rates.

20. The system of claim 12, wherein the memory stores further instructions that, when executed, cause the one or more processors to:
update a module utilized in a customer environment based upon an analysis of the evaluation metric, wherein the updating includes deploying an updated module that modifies one or more parameters of the module based on the analysis.
